(19) United States
(12) Patent Application Publication
(10) Pub. No.: US 2019/0295370 A1
(43) Pub. Date: Sep. 26, 2019

(54) ANONYMOUS PLAYER TRACKING

(71) Applicant: Interblock d.d., Menges (SI)

(72) Inventors: Joze Pececnik, Kamnik (SI); Urban Bergant, Kamnik (SI)

(21) Appl. No.: 16/365,139

(22) Filed: Mar. 26, 2019

Related U.S. Application Data
(60) Provisional application No. 62/648,261, filed on Mar. 26, 2018.

(51) Int. Cl. G07F 17/32; G06K 9/00

(52) U.S. Cl. CPC G07F 17/3239; G07F 17/3255; G07F 17/3211; G07F 17/3206; G06K 9/00288

(57) ABSTRACT

A system and method of tracking an anonymous player of a gaming system. The gaming system includes games that can be played by a player standing or sitting at the gaming system. Sensors determine if the same player remains at the gaming system while playing a plurality of games. A meter tracks the player's activity and/or game results and generates metrics indicating the player's progress toward some goal. When the goal is attained, a coupon or reward of some type may be generated.

### CROSS REFERENCE TO RELATED APPLICATIONS

This application claims benefit under 35 U.S.C. § 119(e) of Provisional U.S. Patent Application No. 62/648,261, filed Mar. 26, 2018, the contents of which is incorporated herein by reference in its entirety.

### TECHNICAL FIELD

The present invention is related to gaming systems and player reward systems for gaming systems.

### BACKGROUND

Gaming systems in casinos that allow players to make bets and play various games of chance on computerized systems typically seek to track each player's activity by encouraging players to identify themselves through use of a registered account. A player may provide the casino with information about themselves, such as a name, address, date of birth, phone number, email address and possibly other information. In return, the gaming establishment may provide the player with a plastic, metal or other material card that includes an identification number and that can be read by various gaming systems in a gaming establishment or used online at the gaming establishment's websites.

When the player seeks to play a gaming system, the player would first insert the card into the gaming system (or allow the card to be scanned in some manner) so the card can be read and the player can be identified. Alternatively, the identification number could be entered in some other manner. While a player is using a gaming system at which the player has registered, information about the player's activity at that gaming system may be recorded, such as amount played, amount won/lost, bet sizes and timing of such bets, patterns of play and other information that could all be analyzed by the gaming establishment to make various determinations about the player, such as whether the player is considered to be a high roller or should be offered certain perks that might not be available to other players.

To the player, the registered account may be presented as a reward system. By registering with the reward system, the player is provided with member discounts, offers for hotel stays, the opportunity to make exclusive reservations for restaurants and shows, etc. Players may also earn points based on their spending habits and be able to redeem those points for discounts on hotel stays, shopping, dining, etc.

Without players identifying themselves during game play, gaming establishments may not be able to identify how much a player is betting, losing/winning, etc., thereby missing important opportunities to identify players the gaming establishment should be paying special attention to in order to encourage them to play more. At the same time, many players dislike gaming establishments tracking their activity and prefer to remain anonymous, yet miss not being able to take advantage of the special attention that would otherwise be paid to them for being a frequent player, high roller, etc.

### SUMMARY

A system and method of tracking an anonymous player of a gaming system are disclosed. The gaming system includes games that can be played by a player standing or sitting at the gaming system. One or more sensors are configured to determine if the same player remains at the gaming system while playing a plurality of games. A meter tracks the player's activity, such as a number of games played, bets made, etc., and/or game results, such as a number of wins or losses, percentage of wins or losses, etc., and generates visual metrics indicating the player's progress towards some goal. When the goal is attained, a coupon or reward of some type may be generated, such as by a printer incorporated into the gaming system.

### BRIEF DESCRIPTION OF THE DRAWINGS

FIG. 1 is a perspective illustration of a gaming system having an electro-mechanical meter system installed in the housing of the gaming system;

FIG. 2 is a perspective illustration of a gaming system having a digital display meter system displayed by the gaming system; and

FIG. 3 is a block diagram illustrating various internal components of the gaming system.

### DETAILED DESCRIPTION OF ILLUSTRATIVE EMBODIMENTS

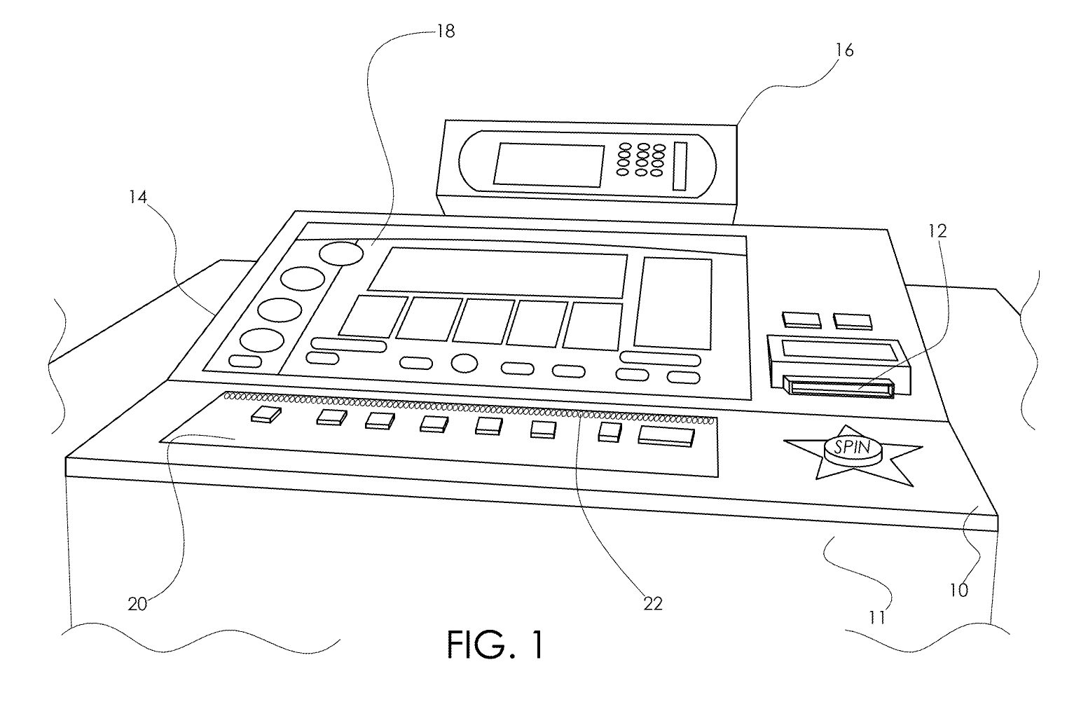

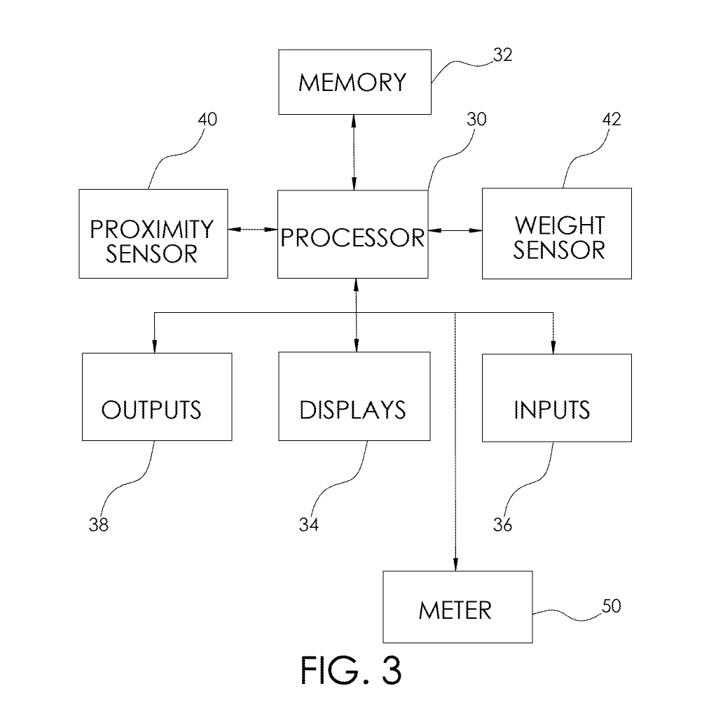

FIG. 1 illustrates a gaming system 10 installed in a physical cabinet 11 positioned somewhere on the floor or in a counter, such as a bar area, within a gaming establishment. As further illustrated in FIG. 3 below, the gaming system 10 may be a computerized system enclosed within the cabinet 11. The gaming system 10 may include a bill acceptor 12 for players playing with physical currency and a printer 14 (such as output 38 of FIG. 3) for printing a receipt indicating any winnings, which may be redeemed elsewhere in the gaming establishment, coupons and other information. The gaming system 10 may also include a player tracking system 16, through which a player may insert an identification card, have the identification card scanned, or have an identification number entered through a key pad and displayed on a small display along with other information, such as player status, acknowledgments, offers and other information.

The gaming system 10 of FIG. 1 may also include a large touch sensitive display screen 18, on its own, or in combination with a button deck 20. The button deck 20 may also be a touch sensitive display of various forms, including a display that displays images of buttons for use by the player in placing bets, selecting cards, and performing other functions associated with a game being played on the gaming system 10. The button deck 20 may also include physical buttons that can be pushed by a user to place bets, select cards, etc., the upper portion of the button deck 20 includes a usage or progression meter 22, as further described below. In the embodiment of FIG. 1, the usage meter 22 may be a row of different colored LEDs that light up from left to right, although other lighting sources and display modes are possible.

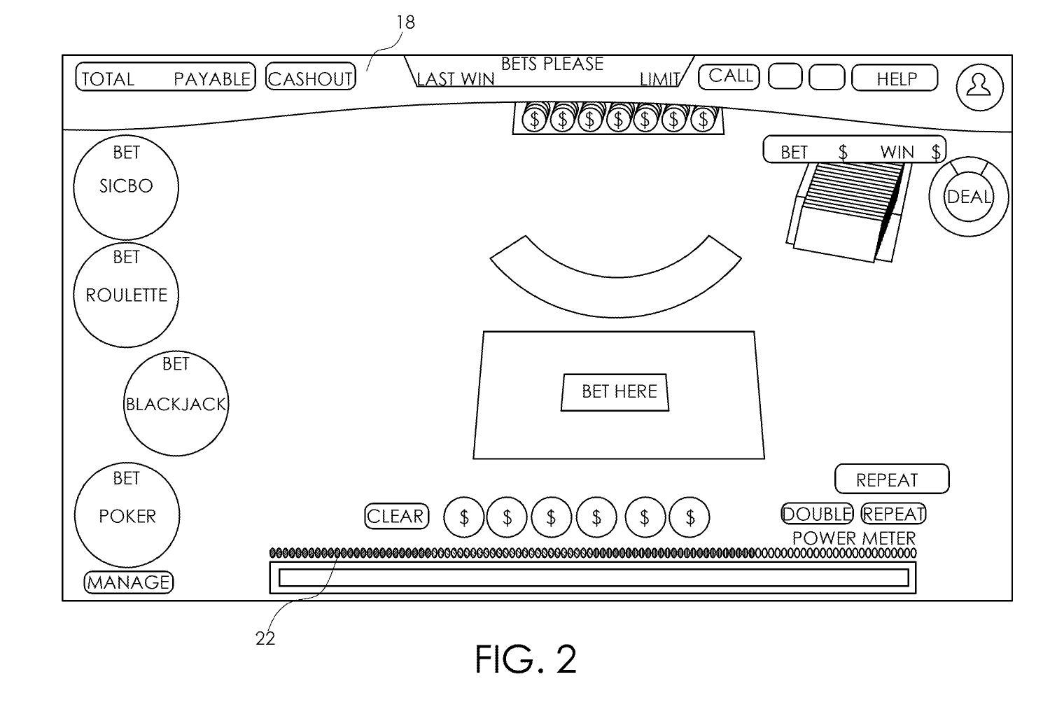

FIG. 2 illustrates the display screen 18 by itself with the usage meter 22 displayed near the bottom of the display screen 18, although other locations around the display screen or gaming system 10 are possible. In either the embodiment of FIG. 1 or the embodiment of FIG. 2, the usage meter 22 may light in a progressive manner to indicate statistics about the current player of the gaming system. For example, the usage meter 22 may indicate how many games in a row a player has played, such that when a player has played a sufficient number of games, the player may be rewarded in some manner by the gaming establishment, which is sent usage meter data by the gaming system 10, which also indicates where the gaming system 10 is located. Alternatively, the usage meter 22 may light up progressively based on the number of games played at a certain bet level, such as a maximum bet. When the player played less than the maximum bet, the usage meter 22 may not change, but each time the maximum bet was wagered, then the usage meter 22 may light up further progressively.

Other usage statistics may also be used, such as numbers of wins, winning percentage, losing percentage, number of losses, etc. The usage meter 22 may be used in any of a number of different manners to create incentives for players to play more. By identifying a player at a gaming system 10 with a usage or progressive meter 22 at a certain level, the gaming establishment could send a gaming establishment employee over to the gaming system 10 to watch the player, for example to make sure there was only one player and not a series of different players, and/or to engage the player in some manner. Alternatively, the incentive campaign associated with the gaming system 10 and the usage meter 22 could be fully automated. For example, once the usage meter 22 has reached a certain progressive level, the printer 14 may be used to print a coupon or something else indicating a reward for the player without requiring additional staff to help with the promotion.

If the player has not provided an identification number to the player tracking system 16, the usage meter 22 may also provide a way of rewarding anonymous players for their use of the gaming system 10, separate and apart from any money or credits they may receive from winning games, which has previously not been possible. In this regard, it may be necessary to identify when a single anonymous player has been using the gaming system 10 so that the player may be tracked and rewarded, versus accidently rewarding the last out of multiple different players that may have used the gaming system 10 over some period of time. For example, in a high traffic area, different players walking by a gaming system might stop and try the gaming system 10 for a few minutes and move on, followed by another player a few minutes later, etc. If the gaming system 10 does not recognize that multiple different players are using the gaming system 10, then it may choose to reward the last player of many by accident.

In an embodiment, the gaming system 10 may include a proximity sensor 40 (shown in FIG. 3), such as an infrared transmitter and detector that is built into the bill acceptor 12 or another appropriate location on the gaming system 10. The proximity sensor 40 may be light based, such as an infrared LIDAR sensor or the like that shines an eye-safe, non-visible light out all of the time in the vicinity of where a player using the gaming system 10 might be located. An infrared light would not be visible or noticed by players. As long as the light was being continuously reflected back to the proximity sensor 40 by a player within a nearby range of the gaming system 10, due to the player's close proximity to the gaming system 10, the gaming system 10 would recognize the presence of a single player and track that player's activity with the usage meter 22. If the player was to stop playing the gaming system 10 and the proximity sensor 40 noticed a break in the light reflection, the tracking of usage meter 22 may stop. A timer in the processor may be used to provide a predetermined period of time during which the reflection may stop and restart without resetting the usage meter 22.

Similarly, a weight sensor 42 (also shown in FIG. 3) may be installed in the seat or in a base platform associated with the gaming system 10. When weight is applied to the seat or platform sufficient to trigger the weight sensor 42 (i.e., a weight heavier than a purse, backpack or other object that a player may be carrying and set on a seat while standing near a gaming system or playing an adjacent gaming system), the usage meter 22 may then track play activity and stop when the weight is removed. A timer in the processor may be used to provide a predetermined period of time during which the weight sensor may stop and restart without resetting the usage meter 22.

A combination of the proximity sensor 40 and the weight sensor 42 may also be used, possibly along with additional sensors, such as body heat detection, facial scanners and recognizers, etc., built into the gaming system 10 or in locations auxiliary to the gaming system 10, but communicatively linked to the gaming system 10. With multiple different sensors deployed, it may be possible to get a more accurate determination as to one player continuing to play the gaming system 10 over an extended period. For example, the weight sensor 42 may turn off, but the proximity sensor 40 may remain on. This may simply indicate that the player has stood up, but not left the gaming system 10, so tracking by the usage meter 22 may continue. Likewise, the weight sensor 42 may remain on, but the proximity sensor 40 may be turned off, which may indicate that the player has leaned back in their seat sufficient to avoid reflection by the infrared light or has turned in some other way sufficient to avoid detection.

When a player completely walks away from gaming system 10, even for a brief period, such as to use the restroom, the weight sensor 42 and proximity sensor 40 may cause the usage meter 22 to reset, thereby zeroing out any usage data associated with that player. It may therefore be beneficial to add a facial scanner and recognition system 44 (also shown in FIG. 3), as noted above, to the other sensors or in place of those sensors. A facial scanner and recognition system 44 may enable an anonymous player to be more dynamically identified and tracked on the same gaming system or between different gaming systems.

The facial scanner may comprise a camera (such as inputs 36) incorporated into the gaming system 10 in an appropriate way sufficient to enable the face of a player, when either standing or sitting, to be imaged. The facial image data may then be recognition processed within the associated processing capabilities of the camera or sent to the processor 30 of the gaming system 10 for recognition, using a facial recognition system, which may be enabled through firmware or software. As part of the recognition process, the facial data may be converted into one or more vectors or other facial indicia that enable a face to be uniquely identified and compared to other faces. Facial indicia may be stored locally, such as in the camera input 36 or memory 32 associated with the processor 30, such that the facial indicia are contained in the gaming system 10, or output by the gaming system 10 to memory associated with a network to which gaming system 10 and other similar gaming systems are connected. A player's usage meter data from the gaming system 10, which is associated with recognized unique facial indicia, may also be stored in association with the unique facial indicia so the status of the usage meter 22 can be restored at the gaming system 10, if and when the player returns to play.

If the facial indicia is stored locally in gaming system 10, the facial indicia may only be used to “recognize’ a player that has previously played that gaming system 10. As such, the facial indicia may only be retained for a period, such as 24 hours. If a player that has played the gaming system 10 returns to it at any time during a period following the player first being “recognized,” then associated usage meter 22 data may be restored to the gaming system 10 so the player can effectively continue building progressive credits where the player left off. Hence, while the player's unique facial indicia has been recognized, no name or other identifier is outwardly associated with the unique facial indicia so the player remains anonymous to the gaming system and the gaming establishment.

The unique facial indicia and usage meter data may also be stored in memory associated with a network to which the gaming system is connected and therefore used at other gaming systems in the gaming establishment, or at other physical locations associated with the player. When an anonymous player returns to any gaming system connected to the gaming establishment's network, the anonymous player's face would be scanned. If the facial indicia for that player is matched with facial indicia for any anonymous player already stored in memory, then the stored usage meter data for that anonymous player could be enabled on the gaming system the anonymous player is using. If the anonymous player then moved to a different gaming system on the same network, the status of the usage meter 22 could be moved to the different gaming system. Accordingly, the facial indicia for the unique face could be stored in server memory associated with a gaming establishment operator and used for gaming systems on different networks at the same facility, or even different networks at different facilities, while still maintaining the player as anonymous.

In an embodiment, facial indicia may be compared to facial indicia for known individuals to identify the anonymous player by name or in some other manner. For example, facial indicia corresponding to faces stored in the player rewards system of a gaming establishment, faces in the profiles of social media systems, or faces associated with a name in other databases may be utilized to identify an anonymous player. Of course, if a player has an identification card or number with a gaming establishment, but is not using that information, there may be a reason the player wishes to remain anonymous. A gaming establishment indicating to such a player that they know who the player is may not sit well. In other instances, players may have simply forgotten to use their identification card or number and might appreciate getting credit for their play. In still other instances, an anonymous player may be identified as someone associated with prior suspicious behavior, associated with an illegal organization, or wanted by the authorities. Depending on the circumstances, the gaming establishment might want to disable any gaming machine they try to use, or let them use the machine while the authorities are contacted. Hence, even if the player is known to the gaming establishment, that player may be treated as an anonymous player for purposes of the usage meter 22.

As illustrated in FIG. 1 and FIG. 2, the usage meter 22 is shown as a row of lights that, from left to right, transition from one color or shade to another, such as from green to yellow to red. The rows of different colored or shaded lights may be the same or different. For example, the first green and second yellow rows of lights may be about the same length, while the red row of lights, only part of which is illuminated, may be twice as long as either of the other rows. The rows of different colored/shaded rows of lights may vary significantly in colors, shades, dimensions, row lengths, etc., as long as the usage meter 22 provided some indication of usage progression to the user. As explained earlier, the usage progression may be indicative of games played, games won, games lost, wages of a certain size played, certain types of wins earned, etc. For example, the usage meter 22 on a blackjack or 21 game that paid a return bet on jacks or better, might not track wins of only a return bet (a single pair of jacks or better), but may track wins that exceed the return bet, such as three of a kind, flush, two pairs, etc. A roulette game may only track wins on single number bets instead of field bets (any black, any red, any even, any odd, etc.) or split bets. As such, the usage meter 22 may include a counter of some form (or the processor for the gaming system may include the counter) to keep track of the identified activity to be tracked and to determine when a predetermined threshold for turning on a light of the usage meter 22 has been obtained.

The display screen 18 may also provide additional information about the usage meter 22 as a player continues to play, such as explaining the rules associated with its use so as to encourage the player to stay at the gaming system 10. For example, once the player has played a few games, the display screen 18 may display a message that says “Continuous Play by a single player at this game will activate the Power Meter. The more games you win, the higher the Power Meter goes. Get to XX and win a prize coupon to be printed at this game,” or something similar. Instead of words, so the operation of the Power Meter is understood in all languages, pictorial images may be displayed showing a player playing a game on the gaming system as the Power Meter grows and printing a coupon when the Power Meter reaches XX, but the Power Meter shrinking back to 0 or turning off when the player leaves the gaming system.

As illustrated in FIG. 3, the cabinet 11 of the gaming system 10 may include a computerized system, including a processor 30, memory 32, one or more displays, one or more inputs 36, one or more outputs 38, and one or more sensors, such as proximity sensor 40, weight sensor 42, and facial scanner and recognition system 44. The processor 30 may be of the type sufficient to run a variety of different games, or a single game, on the display 34, with memory 32 sufficient to support the game and any additional memory required for tracking identified and anonymous players. The display may be simply a display, or an interactive touch screen display that operates as both an input and an output. Other inputs 36 may include the bill acceptor 12, the player tracking system 16, the button deck 20 and other buttons or user interfacing elements that might be installed on the cabinet 11. The outputs 38 may include the printer 14, a sound system (not shown) incorporated into the cabinet 11, cabinet 11 lighting (also not shown), special effects, such as a vibration mechanism for the seating of the gaming system 10 or generated by a base speaker of the sound system located near or under the seating. Many other inputs or outputs may be possible.

The proximity sensor 40 may be an infrared transmitter and detector as discussed above. The weight sensor 42 may be a weight sensor embedded in the seating. Other sensors may include a timing sensor that, in conjunction with the inputs 36 and outputs 38, monitor various player interactions associated with the game and the timing between the various interactions. If the timing between certain interactions is below a predefined threshold for those interactions, the gaming system 10 may determine that the same player is playing games on the gaming system 10, and if the predefined threshold is exceeded, that a different player is now using the gaming system 10, in which case the meter 50 is reset. While the meter 50 could be included in the display 34 or the outputs 38, it could also be a separate system that provides lighting and sound of its own. The meter 50 may include a number of different LED lights or a display configured to display different images, such as simulations of lights or other types of metered activity. The meter 50 could track one or more outcomes of the gaming system 10 or one or more interactions between the player and the gaming system 10.

Having thus described the different embodiments of a gaming system and methods of controlling the same, it should be apparent to those skilled in the art that certain advantages of the described methods and systems have been achieved. In particular, it should be appreciated by those skilled in the art that the meter may be implemented using other forms of microprocessing hardware, software and combinations thereof in a wide variety of environments where the identity of a player may not be known. It should also be appreciated that various modifications, adaptations, and alternative embodiments thereof may be made within the scope and spirit of the present disclosure.

What is claimed:

1. An anonymous player tracking system, comprising:
a gaming system configured to enable an anonymous player to play one or more games while standing or sitting at the gaming system;
one or more sensors configured to identify a presence of the anonymous player at the gaming system while playing the one or more games; and
a usage meter configured to track one or more outcomes of the gaming system and game interactions between the anonymous player and the gaming system, wherein the meter outputs one or more metrics associated with one or more of the outcomes and game interactions while the presence of the anonymous player is identified at the gaming system, wherein the usage meter is reset to a start point when the presence of the anonymous player is not identified at the gaming system.

2. The system of claim 1, wherein the one or more sensors include a proximity sensor configured to determine if the anonymous player is physically near the gaming system.

3. The system of claim 2, the proximity sensor including a light transmitter and a light detector, wherein light transmitted by the light transmitter is reflected by the player when the player is in close proximity to the gaming system, and wherein the light reflected by the player is detected by the light detector when the player is in close proximity to the gaming system.

4. The system of claim 1, wherein the one or more sensors including a weight sensor, the gaming system including one or more components upon which the anonymous player stands or sits while playing the one or more games, wherein the weight sensor is configured to identify the anonymous player as being at the gaming system when the weight sensor detects a weight on the one or more components above a predefined threshold weight.

5. The system of claim 1, the one or more sensors including a timing sensor, the timing sensor being configured to detect a plurality of player interactions with the gaming system and to identify the anonymous player as being at the gaming system when a time between two different player interactions does not exceed a threshold.

6. The system of claim 1, wherein the one or more metrics include lighting.

7. The system of claim 6, wherein the lighting includes a progressive lighting of different colors.

8. The system of claim 1, wherein the meter includes a plurality of LED lights.

9. The system of claim 1, wherein the meter is displayed on a display of the gaming system.

10. The system of claim 1, further comprising a printer for printing a coupon when the one or more metrics exceeds a threshold.

11. The system of claim 1, wherein the one or more sensors include a facial scanner configured to capture a facial image of a player and a facial recognition system configured to identify the facial image and store the facial image in a memory, wherein the one or more sensors are configured to identify the anonymous player as being at the gaming system when the facial image corresponds to a facial image of the anonymous player in the memory.

12. The system of claim 11, wherein the one or more metrics include usage data associated with the anonymous player, wherein the usage data is stored in the memory in association with the facial image of the anonymous player when the one or more sensors determine the anonymous player is no longer at the gaming system, and wherein the usage data is retrieved from the memory when the one or more sensors determine the anonymous player returns to the gaming system based on the facial image of the anonymous player.

13. The system of claim 11, wherein the gaming system is one of a plurality of networked gaming systems, wherein the one or more metrics include usage data associated with the anonymous player at the gaming system, wherein the usage data is stored in the memory in association with the facial image of the anonymous player when the one or more sensors determine the anonymous player is no longer at the gaming system, wherein the usage data is retrieved from the memory when the one or more sensors identify the anonymous player as being at a different gaming system among the plurality of networked gaming system, and wherein the usage data is utilized by the different gaming system while the anonymous player is identified as being present at the different gaming system.

14. A method of tracking an anonymous player of a gaming system, comprising:
detecting the anonymous player having a first interaction with the gaming system;
after the first interaction, monitoring a presence of the anonymous player near the gaming system during a plurality of subsequent interactions;
generating one or more metrics associated with one or more of the first interaction and the subsequent interactions; and
resetting the one or more metrics to a starting point when the presence of the anonymous player near the gaming system is no longer detected.

15. The method of claim 14, wherein monitoring includes monitoring a proximity sensor configured to determine if the anonymous player remains near the gaming system.

16. The method of claim 15, wherein monitoring a proximity sensor includes transmitting a light at the anonymous player and detecting light reflected by the anonymous player when the anonymous player is in close proximity to the gaming system.

17. The method of claim 14, wherein monitoring includes monitoring a weight sensor for a weight on a component of the gaming system above a predefined threshold weight.

18. The method of claim 14, wherein monitoring includes monitoring a timing sensor for a period between two consecutive interactions among the plurality of subsequent interactions that exceed a threshold.

19. The method of claim 14, generating the one or more metrics including lighting one or more lights based on one or more of the first interaction and the subsequent interactions.

20. The method of claim 19, wherein the lighting includes a progressive lighting of different colors.

21. The method of claim 14, wherein the one or more of the first interaction and the subsequent interactions include one or more of a number of games played on the gaming system, a number of games won on the gaming system, a number of games lost on the gaming system, a number of bets at or above a threshold are made on the gaming system, a percentage of game wins on the gaming system, and a percentage of game losses on the gaming system.

22. The method of claim 14, wherein monitoring includes monitoring a plurality of sensors associated with the gaming system to detect the continued presence of the anonymous player near the gaming system over a period.

23. The method of claim 22, wherein the plurality of sensors includes two or more of a proximity sensor, a weight sensor, and a timing sensor.

24. The method of claim 22, wherein the continued presence persists as long as one of the plurality of sensors detects the continued presence of the anonymous player near the gaming system during the period.

25. The method of claim 14, further comprising generating an output when the one or more metrics exceeds a threshold.

26. The method of claim 14, wherein detecting includes monitoring a sensor associated with the gaming system to detect a player near the gaming system, wherein the sensor includes a facial scanner configured to capture a facial image of the player and a facial recognition system configured to identify the facial image and store the facial image in a memory, wherein monitoring includes comparing the facial image to a facial image of the anonymous player in the memory, and wherein resetting occurs when a comparison between the facial image and the facial image of the anonymous player do not match.

27. The method of claim 26, wherein the one or more metrics include usage data corresponding to the anonymous player, and further comprising storing the usage data in the memory in association with the facial image of the anonymous player when the comparison between the facial image and the facial image of the anonymous player do not match.

28. The system of claim 11, further comprising retrieving the usage data from the memory after the one or more metrics have been reset when the comparison between the facial image and the facial image of the anonymous player match.
